(19) United States
(12) Patent Application Publication
(10) Pub. No.: US 2011/0310297 A1
(43) Pub. Date: Dec. 22, 2011

(54) CONSUMER ELECTRONIC PRODUCT HAVING INTEGRATED ROUTER OR GATEWAY

(75) Inventors: John GAWEL, Nashville, TN (US); Nathan SKIRVIN, Nashville, TN (US)

(73) Assignee: Toshiba America Information Systems, Inc., Irvine, CA (US)

(21) Appl. No.: 13/166,211

(22) Filed: Jun. 22, 2011

Related U.S. Application Data
(60) Provisional application No. 61/357,493, filed on Jun. 22, 2010.

(51) Int. Cl. H04N 7/00

(52) U.S. Cl. 348/552; 348/E07.001

(57) ABSTRACT

An example consumer electronic product such as a television includes a router or gateway contained within a housing of the television and a user interface for allowing configuration of settings associated with the router or gateway via one or more displays on a screen of the television.

### CROSS-REFERENCE TO RELATED APPLICATION

This application claims the benefit of provisional application No. 61/357,493, filed Jun. 22, 2010, the entire contents of which are herein by reference.

### BACKGROUND AND SUMMARY

This application generally relates to a consumer electronic product, such as a television, which includes an integrated router (e.g., a wireless router) or gateway.

Consumers typically have a number of devices in the home which require or benefit from connectivity to the Internet. Examples of such devices include televisions, laptop computers, desktop computers, video game systems, BluRay® players, mobile telephone devices, tablet computers, etc.

This application describes incorporating a router (e.g., a wireless router) or gateway within a consumer electronic product such as a television to enable the consumer electronic product to provide wireless internet access for consumer products in the home, and to make one or more wired connections available to co-located devices requiring Internet access.

These and other features and advantages will be better and more completely understood by referring to the following detailed description of example embodiments in conjunction with the drawings.

### BRIEF DESCRIPTION OF THE DRAWINGS

FIG. 1 is a block diagram showing an example television set which incorporates an integrated router.

FIG. 2 is an illustration of an example network configuration menu which allows a user to configure the network.

FIG. 3 is an illustration of a list of submenus for installation of the network.

FIG. 4 is an illustration of an exemplary router setup menu screen.

FIG. 5 is an illustration of an exemplary router setup menu screen.

FIG. 6 is an illustration of an exemplary security setup menu which allows the user to specify the various security settings for the network

FIG. 7 is an illustration of an exemplary remote keyboard for text entry in connection with the setup screens.

FIG. 8 illustrates an example network arrangement.

### DETAILED DESCRIPTION OF EXAMPLE EMBODIMENTS

The following description uses a television as a non-limiting, illustrative example of a consumer electronic product including an integrated router. It will be readily appreciated that the principles and concepts described herein are readily applicable to a wide range of consumer electronic products including televisions, monitors, DVD players, personal video recorders, radios, audio receivers, CD players and the like.

The following description more specifically relates to an example television having a wireless router integrated therein. Generally speaking, the router is incorporated into the housing of the television at the time of manufacture. In addition, as explained below, the television includes software/firmware which allows configuration of settings of the router via one or more displays on a screen of the television. This software/firmware may be included in television memory at the time of manufacture or may be downloaded to the television memory “in the field.” Updates to the software/firmware may also be downloaded to the television memory “in the field.”

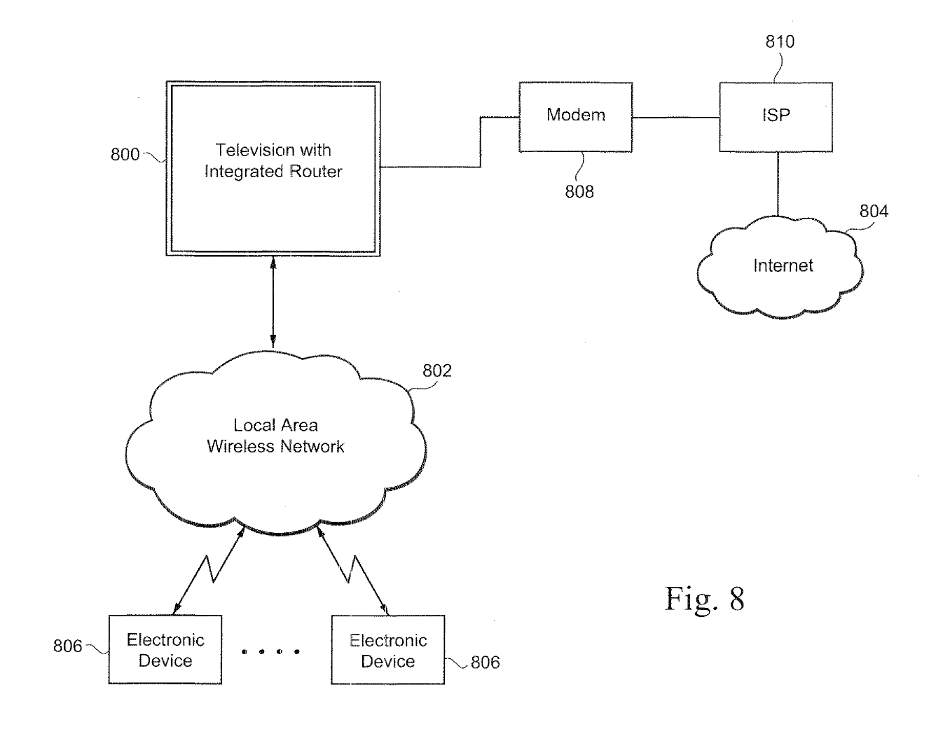

As shown in FIG. 8, an example television 800 with integrated router connects a home local area network (LAN) 802 to a wide area network (WAN) 804 such as the internet. By way of example, the connection to the WAN may be via a cable television network, a satellite network, a digital subscriber line (DSL), a cellular telephone network or the like. A number of devices 806 are connected in the home wireless network 802 and may be connected to WAN 804 via television 800. Devices 806 include computers, home video game systems, personal video recorders (PVRs), DVD recorders/players, mobile telephones, appliances and the like.

Generally speaking, in the examples described herein, television 800 with integrated router allows multiple electronic devices (e.g., computers, home video game systems, PVRs, DVD recorders/players, mobile telephones, appliances and the like) to have internet access. In an example implementation, the router includes a broadband router that, for example, allows devices connected to the local area network to share a cable or DSL internet connection; an Ethernet switch which may include one or more (e.g., four) ports for wired connections to co-located electronic devices; and a wireless access point for wireless communication. The wired connections of the switch may be connected to hubs and other switches depending on the network. The router is connected to a modem such as a DSL or cable modem 808 which provides access to internet 804 via an internet service provider 810.

In another example implementation, the television may include an integrated router along the lines described above along with a modem (e.g., a cable or DSL modem). In this case, the television may be viewed as including an integrated residential gateway.

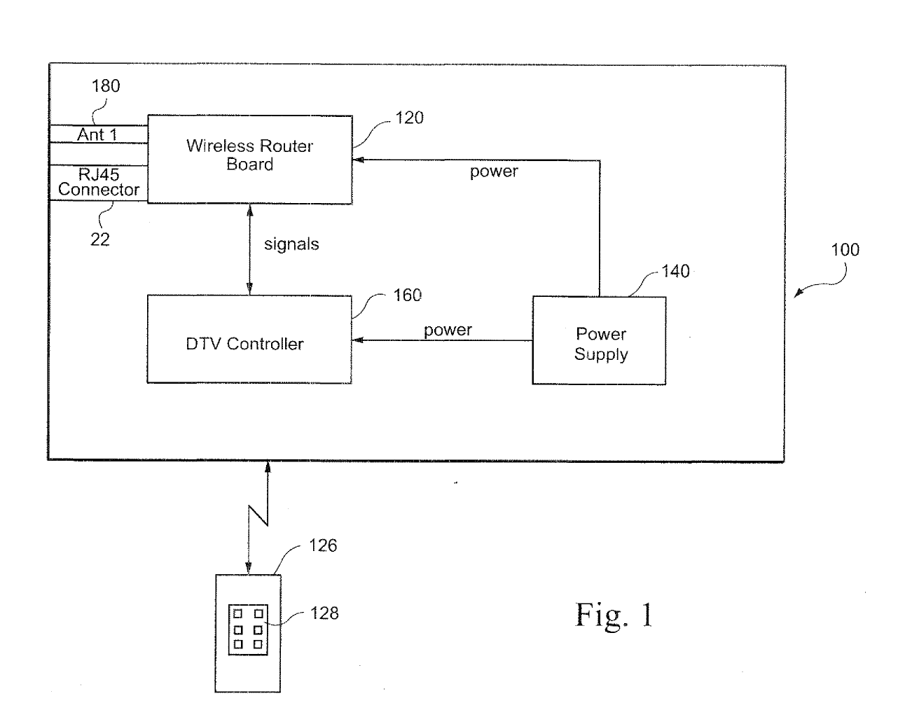

FIG. 1 is a highly generalized block diagram of an example digital television 100 having a wireless router 120 embedded in the body (e.g., cabinet) thereof. The television may include a power supply 140, which provides power to the various components of the television, including router 120 and a digital television (DTV) controller board 160.

Television 100 includes one or more user-accessible connectors associated with the router. For example, a connector 22 (e.g., an RJ45 connector) permits connection of the router to a DSL or cable modem 155, thereby providing connectivity to the internet. Other connectors may include a USB port and one or more additional Ethernet ports for permitting wired connections to relatively co-located devices such as a DVD player, personal video recording (PVR) device, personal computer and the like. These connectors associated with the router may be provided, for example, on a back panel of the television along with other conventional connectors or ports such as those for HDMI, DVI, Firewire, IEEE 1394, S-video, component video, composite video, antenna and the like.

Router 120 may be provided on its own printed circuit board (PCB) and connected by, for example, a ribbon cable to DTV controller 160. In another implementation, router 120 may be integrated with the DTV controller 160.

An example router includes a low-energy central processing unit (e.g., a 32-bit CPU) operating, for example, at 233-300 MHz and supporting MMX instructions; a 64-bit SDRAM memory controller (max: 89 MHz); controller code (BIOS) and executable firmware; 64 to 128 MB SDRAM; compact flash memory (including boot OS) which stores data over power cycles; and monitoring devices such as a watchdog timer and LM77 (National Semiconductor) thermal monitor.

Router 120 also preferably includes a power supply of 7V˜18V external DC power connection. The power supply for the router can be a derived from shared power supply 140 which also supplies power to the other television components or a separate power supply independent of the television power supply.

Router 120 also preferably includes an Ethernet controller, such as National Semiconductor DP83816 or equivalent; a serial data interface for communication with DTV controller 160, and a wireless (e.g., 802.11n) transceiver. The WiFi transceiver allows other devices to connect to the internet via the router.

As noted above, router 120 can provide for wired connections to/from other devices via one or more Ethernet connectors (e.g., RJ45 connector(s)) and is connected to a cable modem or DSL modem via input 22, thereby providing a connection to the internet. Of course, other connections to the internet may be used.

In one exemplary embodiment, antenna 180 of the router's wireless access point is an omni-directional antenna which ensures that the entirety of the area in which the television is located (e.g., a house) can be reached by the wireless signal. However, because a television can include or use an antenna for receiving television signals, care should be taken to avoid interference between the separate antennae. Antenna 180 transmits and receives signals in accordance with any known communication protocol including, but not limited to, Bluetooth, Wireless Fidelity (Wi-Fi) (e.g., IEEE 802.11, 802.11a, 802.11b, 802.11g and 802.11n), WiMAX, Global System for Mobile Communications (GSM), Enhanced Data GSM Environment (EDGE), code-division multiple access (CDMA), time division multiple access (TDMA) and the like.

DTV controller 160 controls the overall operations of television 100 (e.g., channel tuning; I/O processing; and audio/video/data decoding and if needed, decrypting), In general, controller 160 may include, for example, a 32 or 64 bit CPU operating 300-500 MHz range; controller code (e.g., process monitor (PMON)); OS (e.g., Linux); executable firmware; SDRAM (e.g., 128 MB or more); flash memory (preferably at least 64 MB); a DC power connection, preferably from power supply 140, a Seine 4L video controller or equivalent video controller chip; a TV Micro-Controller; HDMI, RGB Component, Composite and VGA video outputs; a TV tuner circuit; an LCD panel controller; an audio processing DSP and audio outputs; and an HDMI controller.

DTV controller 160 may be supplied with user inputs from a remote control 126 having a keypad 128. The keys or buttons on the keypad may be appropriately labeled to assist the user in inputting desired numbers (0-9) or selecting desired functions (e.g., volume up/down; channel up/down; etc.). In an example embodiment, keys on keypad 128 may be used to allow a user to set up and configure the network router using a menu system (described below) and appropriate software/firmware.

One benefit of integrating the router 120 into television 100 is that the television provides a convenient user interface to configure the router and to set up a wireless local area network in a user's home. The user interface may, for example, be generated by software or firmware executed by a CPU of the controller 160.

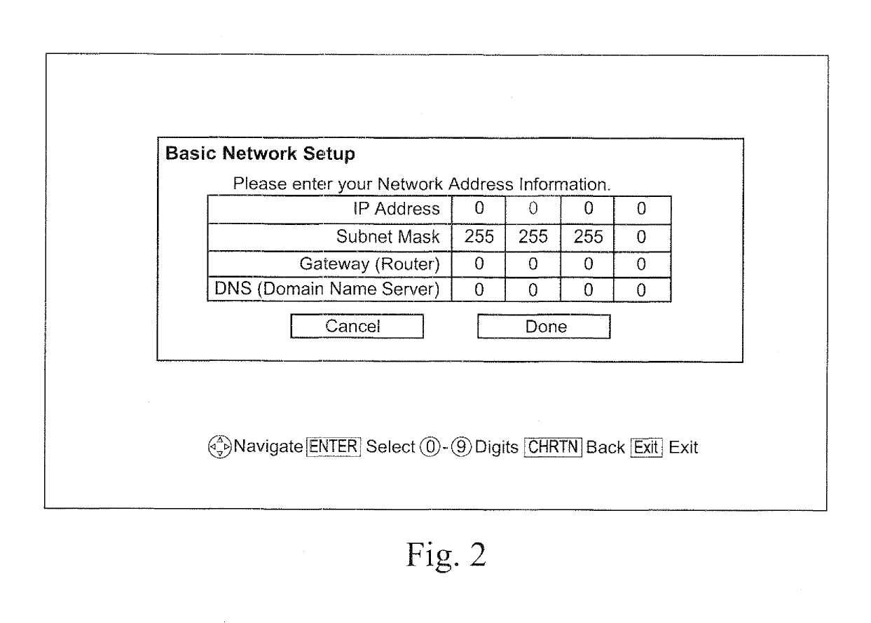

FIG. 2 illustrates an example network configuration menu which allows a user to configure their home network using remote control 126. As shown in FIG. 2, the television may display a Basic Network Setup screen for setting up the network configuration, including the IP address, the subnet mask, etc. The software may be configured with an automatic set-up mode that automatically determines some or all of this information as the user proceeds through the set-up screen(s). In a non-automatic (e.g., manual) mode, the user can input such information using keys of remote control 126. The screen layout of FIG. 2 can be expanded to accommodate common access point/switch settings. Further, if the set-up options require more screen real estate, the interface can be configured so that the user can scroll up/down and/or left/right using remote control 126 or the options can be presented on multiple screens or submenus which may be accessed one at a time as the user proceeds through the setup operation.

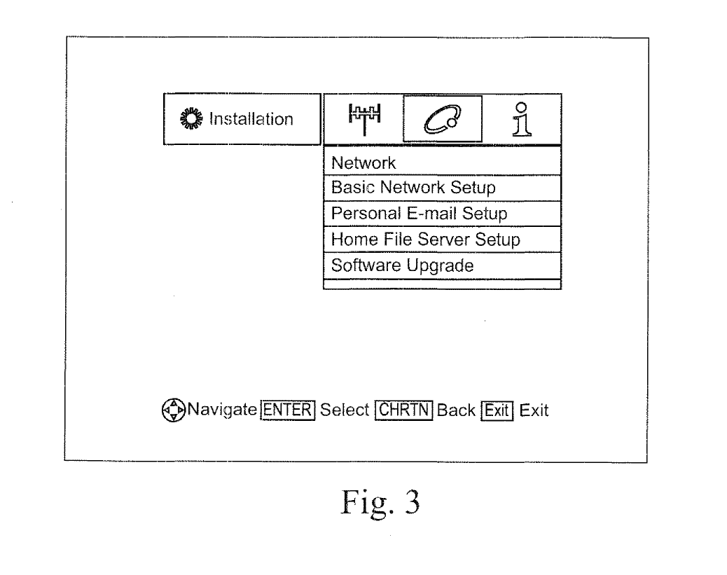

FIG. 3 is a non-limiting illustration of a list of submenus for setting up the network and includes a basic network setup option, a personal e-mail setup option, a home file server setup and a software upgrade option. The user can scroll through this menu to select the various submenus using remote control 126.

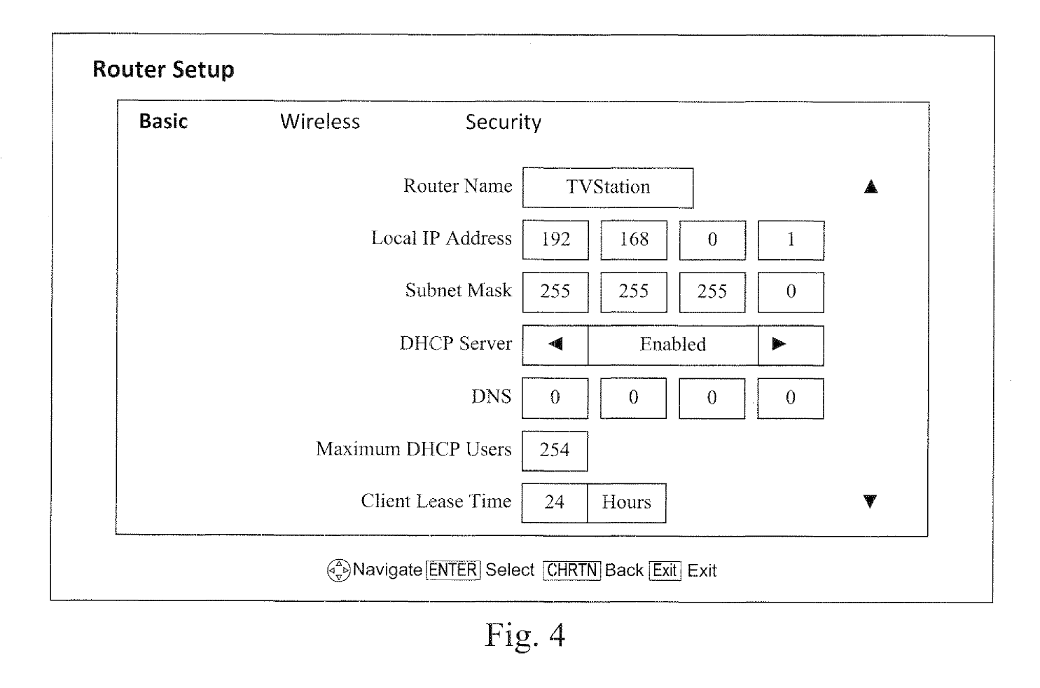

FIG. 4 is an illustration of an exemplary router setup menu screen. The user can scroll through this menu to complete the basic setup of the network. Examples of settings which can be selected at this basic menu are the router name, the local IP address, the subnet mask number, whether the “DHCP Server” feature is enabled, the DNS, the maximum number of DHCP users and the client lease time. It should be appreciated that other basic features could be configured at this basic setup screen.

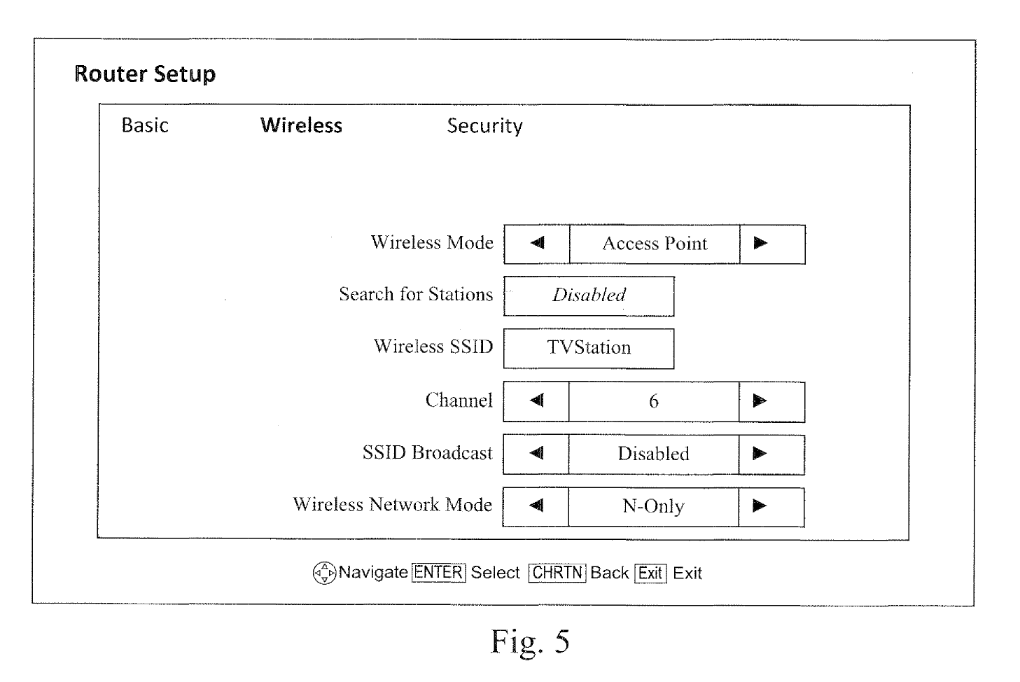

FIG. 5 is a non-limiting illustration of an example router setup menu screen which allows the user to specify various wireless settings. Examples of the various settings which can be specified by the user at this screen include the type of wireless mode, whether the “Search for Stations” feature is enabled, the wireless SSID, the channel, whether the “SSID Broadcast” feature is enabled and the type of network mode, i.e., n-type, g-type, etc. It will be appreciated that other router features could be configured at this router setup screen.

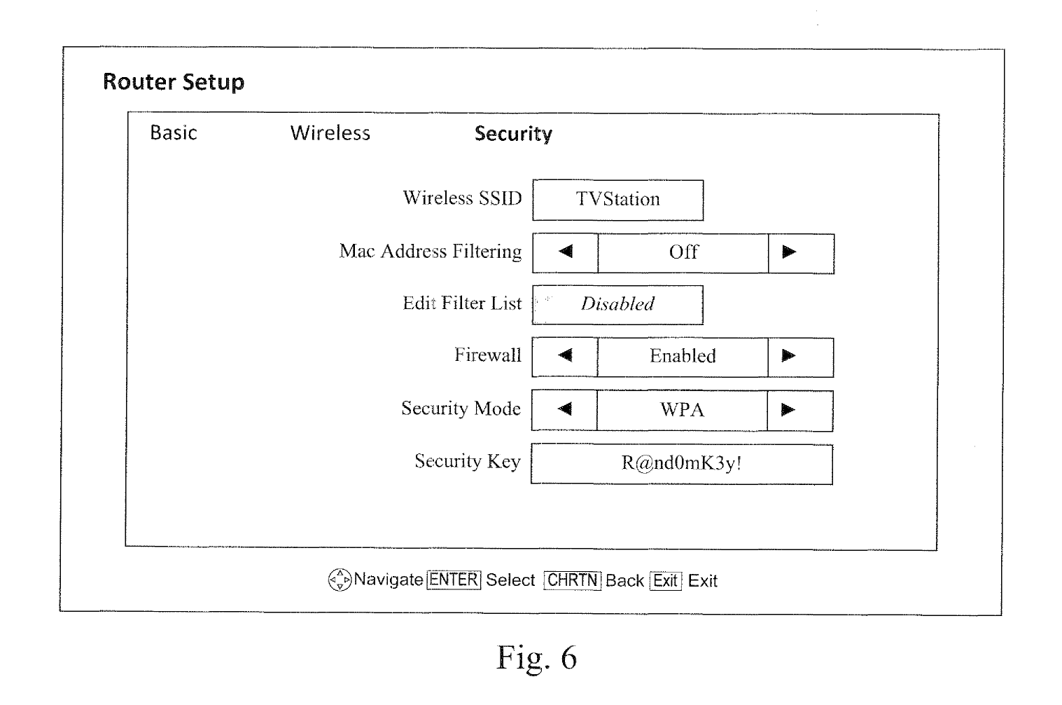

FIG. 6 is a non-limiting illustration of an example security setup menu screen which allows the user to specify various security settings for the network. Examples of the various settings which can be chosen by the user at this screen are the wireless SSID, whether the “MAC Address Filtering” feature is enabled, whether the “Firewall” feature is enabled, the security mode and the security key. It will be appreciated that other router features could be configured at this security setup screen.

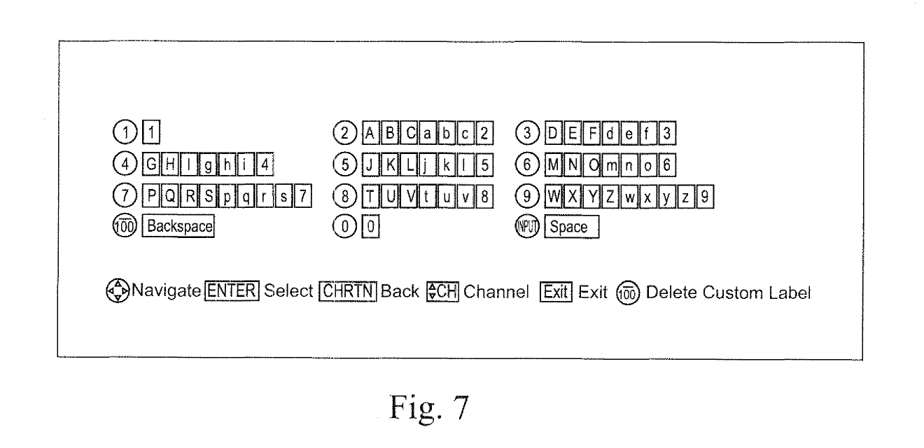

FIG. 7 shows an example remote keyboard for text entry in connection with the setup screens described previously. For example, if the user presses the “1” key of the front panel keys 28, a “1” would be entered on the screen. If the “2” key of the front panel keys 28 is pressed once, an “A” would be entered on the screen, If the “2” key is pressed twice, a “B” would be entered on the screen. Other configurations could be used for various corresponding front panel keys with the various letters and numbers to allow the user to configure the network via the remote control 26.

Generally speaking, the systems, methods, and techniques described herein may be implemented in digital electronic circuitry, computer hardware, firmware, software, or in combinations of these elements. Apparatus embodying these techniques may include, for example, appropriate input and output devices, a computer processor, and a computer program product tangibly embodied in a machine-readable non-transitory storage device for execution by a programmable processor. A process embodying these techniques may be performed by a programmable processor executing a program of instructions to perform desired functions by operating on input data and generating appropriate output. The techniques may be implemented in one or more computer programs, applications, scripts, applets, routines, subroutines, etc. that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of volatile and non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits). The computer program instructions may also be provided as data signals embodied in a carrier wave or other propagation medium via a communication link (e.g., a modem or network connection).

The systems and methods described herein are not limited to the disclosed embodiments, but on the contrary, are intended to cover various modifications and equivalent arrangements included within the spirit and scope of the appended claims.

We claim:

1. A television, comprising:
a router contained within a housing of the television; and
a user interface for allowing configuration of settings associated with the router via one or more displays on a screen of the television.

2. The television according to claim 1, wherein the router includes a wireless access point.

3. The television according to claim 1, wherein the router includes an input for connection to a modem.

4. The television according to claim 3, wherein the modem comprises a cable modem.

5. The television according to claim 3, wherein the modem comprises a DSL modem.

6. A television, comprising:
a gateway contained within a housing of the television; and
a user interface for allowing configuration of settings associated with the gateway via one or more displays on a screen of the television.

7. The television according to claim 6, wherein the gateway includes a wireless access point.

8. The television according to claim 6, wherein the gateway includes a modem.

9. The television according to claim 6, wherein the modem comprises a cable modem.

10. The television according to claim 6, wherein the modem comprises a DSL modem.
